(19) United States
(12) Patent Application Publication
(10) Pub. No.: US 2014/0194181 A1
(43) Pub. Date: Jul. 10, 2014

(54) METHOD AND SYSTEM FOR PLAYING BINGO GAMES VIA A PROXY PLAYER

(71) Applicant: Ronnie W. Harris, Las Vegas, NV (US)

(72) Inventor: Ronnie W. Harris, Las Vegas, NV (US)

(21) Appl. No.: 14/154,803

(22) Filed: Jan. 14, 2014

Related U.S. Application Data
(63) Continuation of application No. 13/470,537, filed on May 14, 2012, now abandoned.
(60) Provisional application No. 61/487,211, filed on May 17, 2011.

(51) Int. Cl. G07F 17/32

(52) U.S. Cl. CPC G07F 17/3286
USPC 463/19

(57) ABSTRACT

A remote player at a first location which is remote from a second location where a bingo game is being presented is able to participate in the bingo game via a proxy player at the second location. The remote player may provide instructions to the proxy agent who uses financial account information to purchase and play bingo cards on behalf of the remote player. Winning and losing outcomes are reported to the remote player. Awards for winning outcomes may comprise the award of one or more additional game cards for the same bingo game or other bingo games.

### RELATED APPLICATION DATA

This application is a continuation of U.S. patent application Ser. No. 13/470,537, filed May 14, 2012, and claims priority to U.S. Provisional Patent Application Ser. No. 61/487,211, filed May 17, 2011.

### FIELD OF THE INVENTION

The present invention relates to games, and particularly to a method and system for enabling play of a bingo game through a proxy agent.

### BACKGROUND OF THE INVENTION

Bingo is an old and well-established game. Because so many people enjoy the game of bingo, it has been adapted as a widely played game of chance in many formats and media, including but not limited to paper cards or electronic bingo systems. In these games, players purchase game cards for a chance to win a prize if they cover a predetermined pattern within the rules of the game being played.

One problem with traditional bingo games is that they require the player to be physically present where the game is being presented. This may prevent many players from being able to participate in bingo games. For example, elderly players may have difficulty traveling to a bingo hall, even if it is very close. In other instances, a player might be located many hours or a day's drive from a location where a bingo game is being presented, making in unreasonable for the player to travel to play the game.

Some solutions have been proposed to this problem. First, with the advent of electronic gaming systems and communication devices, systems for remote participation have been devised where a player might play games via a computer or the like. For example, a player might be required to download specific bingo game software to allow the player to play games at their computer. One problem with many of these systems is that they are very complex and require specialized equipment and software. This equipment and software may be difficult to use and may also be expensive. Also, various existing laws and regulations currently impact the ability of players to directly play games from remote locations, especially if the player is located in a jurisdiction where gambling is illegal.

One system and method of proxy bingo play is detailed in U.S. Pat. Nos. 5,830,067 and 6,306,038. While these patents disclose the concept of bingo game play via a proxy player machine, various problems arise when attempting to implement such a system. Some of these problems include ensuring that the remote player is not cheated and addressing awards of monetary winnings to the remote player for bingo game outcomes.

### SUMMARY OF THE INVENTION

The invention comprises methods of presenting and playing games and gaming machines, utilizing interfaces and providing gaming systems for presenting games. One embodiment of the invention is a method and system for playing and presenting one or more bingo games utilizing a proxy agent or player.

In an embodiment of a bingo game, a remote player at a first location is enabled to view results of a bingo game being presented at a second location which is remote from the first location. In one embodiment, a player establishes a financial account, preferably at the location where the bingo game is being offered and permits a proxy agent at the location to purchase and play bingo cards on behalf of the player. The proxy agent may be electronic, may be operated by a live individual and/or be automated. The player may transmit instructions from the first location, such as their home, to a proxy agent located at the second location where the bingo game is being presented. The proxy agent purchases one or more bingo cards for the remote player using their financial account.

One or more bingo cards are assigned to the proxy agent on behalf of the player. One or more initial sets of one or more bingo numbers or designations are selected. Such numbers or designations may be represented on or as “bingo balls.” Those bingo numbers or designations are matched to numbers or designations on the purchased bingo cards. If one or more winning outcomes result from the matching/comparing, the player is awarded the award for each winning outcome in accordance with the pay table. Bingo card daubing or other game-related activities are performed by the proxy agent for the player.

In a preferred embodiment, awards for winning bingo game outcomes are made to the player in the form of one or more game cards. The player or proxy agent may play those game cards in accordance with the rules for those game cards. If the game cards comprise one or more additional bingo cards for the current bingo game, the player or proxy agent may play those cards by matching bingo numbers or designations to the one or more additional bingo cards.

In accordance with the invention, a player is permitted to play a bingo game at a location remote from where the bingo game is presented by utilization of the proxy agent. Such a remote player has the opportunity to win one or more additional game cards. The additional game cards increase the excitement associated with the play of the game and afford the player additional opportunities for winning outcomes and associated awards.

The game may be implemented via a game system. Such a system may include kiosks for purchasing bingo card sets, proxy agent stations, electronic player interface devices or gaming machines (referred to throughout as gaming machines) linked to one or more game servers, and interface hardware and software applications for the system. In such embodiments, paper or electronic bingo cards may be generated and displayed. The system may include one or more proxy agent stations which are configured to receive or at which remote player instructions may be input and via which the proxy agent may play the bingo games for the remote player. The system may also include an accounting system or host for storing remote player financial account information. The system may also include a transaction host which is configured to monitor and store remote player instructions and proxy agent game play to ensure the integrity of the game play. The system may also include specified interface applications which may be comprised of computer software or hardware for ensuring compliance of the system and aiding the player experience.

Further objects, features, and advantages of the present invention over the prior art will become apparent from the detailed description which follows, when considered with the figures provided herein.

### DESCRIPTION OF THE DRAWINGS

FIG. 1 is a flow diagram of a method of bingo game play in accordance with the invention;

FIG. 2 illustrates gaming machines and a gaming system which may comprise an environment in which an embodiment game of the invention may be implemented;

FIG. 3 illustrates an example bingo card for playing a bingo game of the invention; and

FIG. 4 illustrates a portion of a pay table for a game in accordance with the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the invention comprises a method of presenting and playing a game and gaming machines, utilizing interfaces and providing systems for presenting games. A preferred embodiment of the invention comprises a method and system for playing and presenting one or more bingo games to a remotely located player utilizing a proxy player or agent.

In accordance with the invention, a bingo game is presented at a first location. The first location might comprise, for example, a tribal casino located on tribal land. As detailed below, as one aspect of the invention, a player who is located remote from the first location is enabled to participate in the bingo game via a proxy player or agent.

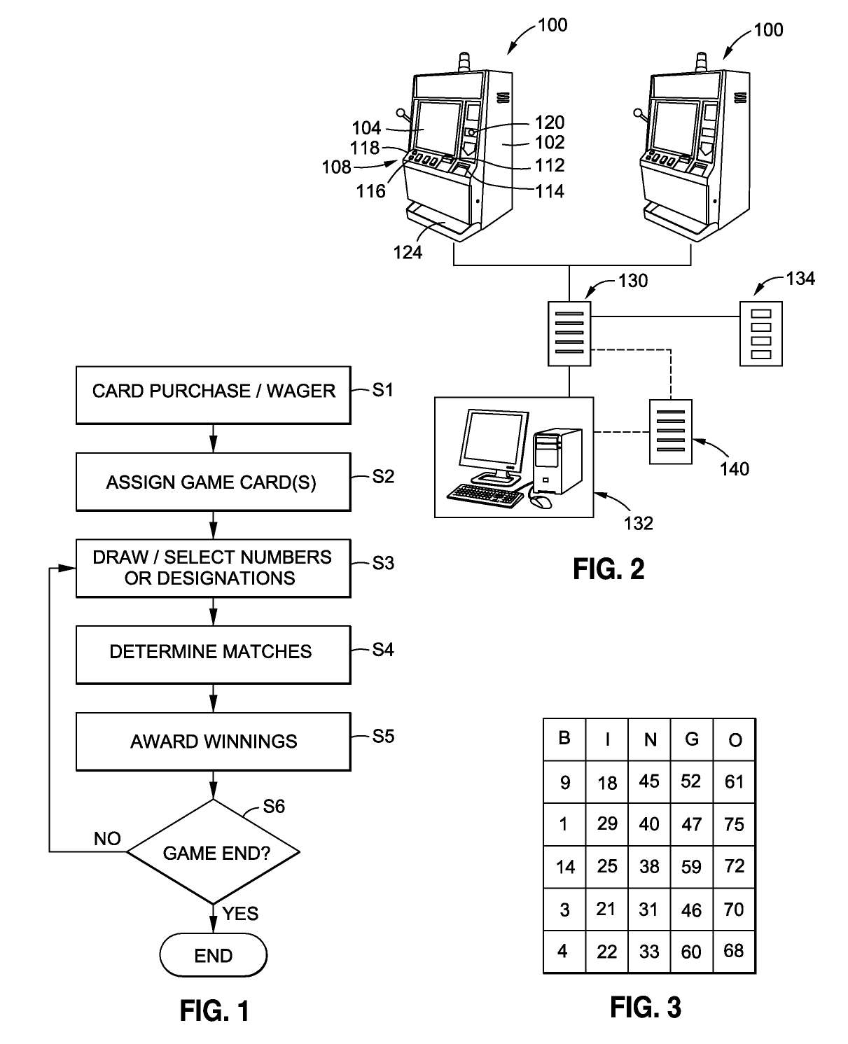

FIG. 1 is a flow diagram of a bingo game as presented at the first location. In one embodiment in step 51 a player purchases a bingo card or places a wager. As indicated above, such may comprise a player providing a number of credits at a gaming machine. This step might also comprise a player providing monies to an operator. Relative to the game of bingo, a player may be permitted to purchase bingo cards having different values, such as “base” value cards (such as “one credit” cards) or higher value cards, such as “max” value cards (purchased for two or more credits). The particular purchase prices or values of the cards may be determined by the operator or bingo game provider.

One or more bingo or game cards are assigned to the player in a step S2. In one embodiment, a player might purchase two or more cards, and such cards may be assigned to the player. The cards may be purchased on a gaming device or at a kiosk. The game cards may be provided electronically or in paper form. For example, relative to the system illustrated in FIG. 2 and detailed below, upon a player placing a wager, a server 130 may assign a game card to a player and transmit game card information to the gaming machine 100 that the player is playing. This game card may be displayed to the player at the gaming machine or kiosk.

The bingo or other game card may have various configurations. Preferably, the game card bears numbers or other designations. For example, the card might comprise a paper or electronic bingo card having numbers arranged in a 5 by 5 grid (totaling 25 numbers arranged into five rows and five columns) The numbers on the cards might comprise numbers selected from the group of numbers 1-75, which numbers are randomly assigned to the locations of the card. In some embodiments, numbers from the group 1-15 are randomly selected for the 5 spots of the first column, numbers from the group 16-30 are randomly selected for the 5 spots of the second column, etc. for each card. One card configuration is illustrated in FIG. 3 wherein numbers 1-75 may be associated with columns designated “B” “I” “N” “G” and “O” and balls or objects may be similarly marked (such as B5; N42, etc.)

In one embodiment, certain criteria may have to be satisfied before a game can be initiated. For example, in a bingo-type game, two or more players may be required before a game can begin. Thus, two or more players may be required to purchase game cards or place wagers before the game begins. Such players may be “local” players, i.e. players who are playing the bingo game at the location where it is offered, or one or more of the players may be players who are playing the bingo game via one or more proxy agents, as detailed below.

When the game begins, one or more objects which are similarly numbered or designated as the game cards are drawn or selected, as in a step S3. In one embodiment, objects may comprise bingo balls, either in electronic or physical form, which are numbered with the numbers one to seventy-five (1-75). The balls or other objects may be physical objects or may be electronically represented.

In one embodiment, the objects may be selected in one or more sets or “draws”. For example, in one embodiment of a game, there is a first single ball draw of thirty (30) numbers or designations which may be represented as balls. In another embodiment, the initial draw may be broken down into two or more sets of balls drawn such as a first draw of one (1) number or designation and then a second ball draw of twenty-nine (29) numbers or designations. In another embodiment, additional bingo balls may be drawn after the initial set of bingo balls are drawn.

In the game of bingo, the numbers or other designations associated with the objects are compared to the numbers or designations on the cards to determine matches and potential wins, as in step S4. It is noted that the process of matching may require input from the player or a proxy agent as the case may be (such as requiring a player to place a “daub” button), and may be required relative to each group or draw of numbers or designations (for example, the player or proxy agent may be required to “daub” after a first single numbers or designation is drawn and then again after the 29 additional numbers or designations are drawn, relative to the example ball draw indicated above). The comparison may be accomplished automatically or manually. For example, a player or proxy agent might select a “daub” button to affect the gaming machine's marking of all matches of drawn or called numbers or designations to those on each of their cards. In other embodiments, such might occur automatically or the player or proxy agent might be required to mark each match.

In one embodiment, one or more predetermined game outcomes are determined to be winning outcomes. In a game of bingo, the winning outcomes may be particular patterns of matches of the numbers or other designations on a card, such as a diagonal, horizontal or vertical line of player numbers, an “X” pattern or the like. The one or more predetermined winning combinations may have prizes associated therewith, as in step S4. One or more winning combinations may be deemed “game ending” patterns in that once received, they cause the game to terminate or bring the game to an end, as in step S5 (the other winning outcomes may be termed “interim” winning outcomes or patterns, since they result in win to the player, but do not end the game). As part of the determination of winning outcomes, associated prizes may be awarded.

Thus, during the course of game play, one or more players may receive interim winning outcomes based upon matches of their card(s) to the one or more initial ball draws. In addition, one or more players might receive the game ending pattern based upon the one or more initial ball draws. As indicated, one or more additional balls may be drawn until a game-ending pattern is received.

In one embodiment of the invention, one or more awards are associated with the designated winning outcomes. Awards for winning outcomes of the game or bingo card may be defined by a pay table. The pay table may set forth which outcomes of the game are winning and the particular awards for those winning outcomes. When the game is presented via an electronic gaming machine or a gaming system, the pay table may be stored in a memory or data storage device of the gaming machine or a server of the gaming system.

Such a bingo game may be presented in “paper form”, such as by a caller calling numbers for matching to numbers printed on physical bingo cards. However, in a preferred embodiment, as indicated above, the bingo game may be presented via or at one or more gaming machines, or kiosks or other electronic display devices. FIG. 2 illustrates one embodiment of a gaming machine or device 100. The gaming machine, kiosks or other electronic display devices 100 might be located in various environments, such as a casino. Preferably, the gaming machine 100, kiosk or other electronic display devices are configured to allow a player to purchase bingo cards or opportunities to play configured to present one or more games to a player which offers the possibility of a prize or winnings. In another preferred embodiment, the results of the bingo cards purchased by a player, which may be paper or electronic cards, may be displayed on a gaming machine, kiosk or other electronic display device.

The gaming machine, kiosk or electronic display 100 may be configured to present a wide variety of games. In a preferred embodiment, as detailed below, the game may be a bingo or bingo-based game. However, the games might be other types of games such as, but not limited to, pull-tab games, lotto or instant lottery style games. Additionally, in a preferred embodiment of a bingo game, the bingo game card outcomes may be presented in various ways, such as a video embodiment of a mechanical reel spinning game, a video poker game display, a keno game, a roulette wheel, baccarat or other casino gaming style. In one embodiment, certain game outcomes may be designated as winning outcomes. Prizes or awards may be provided for winning outcomes, such as monetary payments (or representations thereof, such as prize of credits), or the like. As detailed below, one or more of the awards may have certain characteristics or features.

In one preferred embodiment, the gaming machine, kiosk, or electronic display device 100 includes microprocessors or controllers (not shown) for creating game interfaces and controlling the bingo game system, including receiving player or proxy agent input and sending output signals for controlling the various components of the bingo game system 100 (such as generating game information for display by the display 104). The interfaces and controllers may be arranged to receive input such as a purchase/bet signal when a purchase/bet button is depressed or otherwise directed by a player or proxy agent. The interfaces and controller may be arranged to send signals for determining winning combinations and to cause a display to display winning amount information. In addition, the controller is preferably arranged to determine if a round of game play has resulted in a win, and if so, the prize to be awarded to the player for that win.

The interfaces and controllers may be configured to execute machine readable code or “software” or otherwise process information, such as obtained from a remote server. Software or other instructions may be stored on a memory or data storage device. The memory may also store other information, such as pay table information, player account information, player proxy agent designation information and identification verification. The gaming systems 100 may also include one or more random number generators for generating random numbers used to select bingo numbers or the like, for presenting the game in a random fashion.

In operation, the player or proxy agent may initiate game play by providing value. In the case of a bingo game, this may comprise purchasing one or more bingo cards. In other types of games, this may comprise placing a wager. The purchase or wager is made by a player or proxy agent activating one of the player input devices 108 such as a one credit button 116 which places a single credit purchase or wager or a max credit button 118 which places a maximum purchase or wager for that round of game play. In another embodiment, the player may initiate game play by purchasing cards from a kiosk, game server or proxy agent device unit directly or through the use of a proxy agent. Upon making a purchase or placing a wager, the game may begin automatically, or the bingo game may not begin until other configuration conditions are met, the player may join a game already in progress, or the player may initiate the game by activating another player input device, upon which the gaming system 100 presents one or more game elements which are used to determine if the player has received a winning combination.

The gaming machine 100 generally includes a means for awarding a player a prize or winnings accumulated during game play. When a player obtains a winning outcome, the player is preferably paid prizes or awards in the form of stored credits, the amount of which is indicated to the player on the display 104. A “cash out” button may be provided for permitting a player to be paid the winnings or redeeming any credits initially paid into the gaming machine 100. The term “cash out” is used herein to define an event initiated by the player wherein the player receives a number of coins or currency that is equivalent to the value of the player's accrued credit base.

Typically when a player cashes out, the player receives either a paper currency voucher or currency in the form of a cash or coin disbursement. If the player decides to receive a coin disbursement, the gaming machine 100 activates a coin hopper or coin handling device (not shown) which physically counts and delivers the proper number of coins to the player. The coin handling device is commonly configured to transport coins from a supply source (hopper or bin filled with coins) to a coin tray 124 or payout receptacle where the player physically receives the coins. The player might also elect to cash out by having a ticket or other media dispensed, such as via a printer 114.

The gaming machine 100 may be configured to be in communication with one or more external devices at one or more times. For example, the gaming machine 100 may be configured as a server based device and obtain game code or game outcome information from a remote server. The gaming machine 100 may also communicate with a remote accounting server and/or player tracking server, an electronic proxy agent unit. As indicated below, a preferred embodiment of the invention is a bingo game which involves two or more players. In such a game, each player may play the bingo game on a different gaming machine 100.

In a preferred embodiment, the gaming machines 100 are essentially game kiosks or interfaces and two or more of the gaming machines 100 are configured to permit different players to play the same bingo game being offered via a central server 130. The central server 130 may generate game information which is provided to the gaming machines 100 which are in communication therewith. For example, the central server 130 may start bingo games, draw or select bingo balls/numbers, generate and/or distribute game cards, verify matches and winning outcomes and the like.

It will be appreciated that the gaming machine and system described and illustrated in FIG. 2 is only exemplary of an environment for a game of the invention. For example, it is possible to implement the game via other types of gaming devices, such as hand-held devices and computing devices such as home and laptop computers, such as via an on-line, web-based environment. It is also possible to implement the game in non-electronic environments. For example, relative to a bingo game, physical printed cards could be distributed to players. In participating in the bingo game it is also possible to utilize an electronic or in-person proxy agent to establish a player account for a player, then purchase and play bingo cards in an electronic or paper form, regardless of whether that player is present at the bingo game or not.

When the game is presented via a gaming machine, such as by the system illustrated in FIG. 1, various of the steps of the invention may be performed by the gaming machine and/or server. For example, the game server may be configured to generate game cards, randomly select balls or game numbers, track and display matches of game numbers to game cards, and confirm whether a player's eligibility for the progressive prize. In such a configuration, steps of the game might be implemented via machine readable code which is stored at a memory of the gaming machine and executed by the controller of the gaming machine.

Obviously, a player who is physically located at the location where the bingo game is being presented may play the game. For example, such a player may participate in the bingo game by purchasing bingo cards at a gaming machine 100 or by purchasing physical bingo cards and then matching bingo numbers to the numbers on the purchased cards.

However, in accordance with the invention, a player located in a location remote from the location where a bingo game is being presented is also able to view the presentation of the bingo game outcome. Such a player, who may be referred to as a “remote player”, may be located at a second location remote from the first location where the bingo game is presented. As one example, a bingo game might be presented at a tribal casino located in state A. The remote player might be located at their home in state B. Of course, the actual distance between the location where the game is being presented and where the remote player is located may vary and be a relatively short distance or a very long distance. Also, the remote player might be located in a home, business or various other locations.

In a preferred embodiment of the invention, a player can participate in the play of one or more bingo games via a proxy agent or player. In one embodiment, the proxy agent or player is a physical person who enables play of the bingo game for another player, in person or remote from the bingo game.

In one embodiment, a player establishes a financial account in order to fund bingo card purchases and game play. The player might establish a financial account in person at a tribal casino. For example, the player might travel to a casino and set up an account via a proxy agent device or an account representative of the casino. Another implementation may be that a player uses a kiosk or other device at the casino to establish an account with a proxy agent, whether the agent is a person utilizing an electronic device or an automated electronic device.

In establishing a financial account, the player may be required to provide various identifying information, such as their name, address, telephone number, email address and the like. The player may be provided an account number and may select or be assigned a password or other information for identifying and accessing their account in the future. In a preferred embodiment, specified interfaces and controller units may be utilized with the system for verification and secured archiving of information of the player for future player use and historical purposes.

The player may also be required to provide funds or be required to provide information by which funds may be accessed. For example, in establishing an account a player might deposit monies with the casino or provide bank account or other funds access information. In another embodiment, the player may deposit monies or funds utilizing specialized interface and controller units that would verify currency and funds from sources for the player account funding.

In one embodiment of a system, as illustrated in FIG. 2, accounting information may be maintained and tracked by an accounting system or host 134. The accounting system or host 134 may comprise one or more computing devices such as servers and peripheral devices. Preferably, the accounting host 134 is in communication with the game server, electronic display devices, kiosk units and proxy player electronic devices 130.

In one embodiment, the accounting host 134 may store player account information. Such account information might be inputted by a casino representative via an input terminal or the like. In another embodiment where the system includes a proxy agent station 134, the player may open the account via the proxy agent and the account information may be provided from that station 134 to the accounting host 134. Likewise, if the system includes an account kiosk (not shown), the player may directly provide account information via that kiosk to the accounting host 134.

As indicated above relative to the play of the bingo game, in order to participate in a bingo game, a player preferably purchases one or more bingo cards. The player may receive electronic or paper bingo cards. Additionally, the player may purchase electronic or paper bingo cards via the proxy agent, which may be a live person or which may be via an electronic proxy agent or kiosk terminal, which in turn communications with a live or electronic proxy agent. A player may elect to not have all paper or electronic cards purchased played at the bingo game facility In the case of a remote player, the remote player preferably purchases cards via a proxy agent with funds provided via the remote player's account.

In a preferred embodiment, the player provides wagering instructions to the proxy agent. These instructions may include information regarding what bingo games the player would like to play, the denomination(s) of the bingo cards the player would like to purchase, the number of bingo cards the player would like to purchase, and account information for affecting the purchase, among other information. For example, the remote player might indicate that they wish for the proxy agent to purchase 100 $1.00 denomination bingo cards. The player might provide their account information, such as account number and password, in order for the proxy agent to affect the purchase.

The player might provide instructions via a printed form, a telephone order, or electronically. For example, the player may provide instructions to the live or electronic proxy agent at the gaming facility or the player might send instructions from their home or business computer, cell phone, PDA or other electronic device. In one embodiment, the player may provide these instructions from specific interface and controller units necessary to permit the implementation of such instructions. In another embodiment, instructions may be input into an interactive website which the player accesses from their location either at or away from the casino or other location where the bingo game is being presented.

A player may set up financial accounts with multiple casinos and thus desire to play games at two or more casinos. In such event, the player may be required to contact a proxy agent at each casino at which the player wishes to play a bingo game. This may involve the player accessing particular different websites for each casino or otherwise transmitting different sets of instructions to the proxy agent at each casino.

Some casinos may offer multiple bingo games. The player may be permitted to pick the particular game they would like to play via the proxy agent, at a particular casino. The casinos might offer information via a website or the like of the various bingo games, including information regarding winning outcomes and associated prizes (generally known as “pay table” information), along with the names or other identifiers of such games, thus permitting the player to select particular games for play.

Preferably, the player's instructions are provided to the proxy agent. In one embodiment, the proxy agent may input those instructions or effect those instructions by one or more proxy agent stations 132 associated with the system. For example, the proxy agent may utilize a game interface to access the game server 130, including providing account information which is used by the game server 130 to verify and deduct or charge the player's financial account via the accounting host 134.

In other embodiments, it is possible for the proxy agent to directly play one or more of the gaming machines 100. For example, upon receiving game instructions, the proxy agent might travel to one of the gaming machines 100 and use the player's account information to fund the purchase of the desired bingo cards. The proxy agent station 132 has the advantage that the proxy agent can receive, review and input instructions from various remote players using the station. In another example, an electronic proxy agent may purchase and play bingo cards on a gaming machine on behalf of a player.

In the event the bingo game is played using paper or printed bingo cards, the proxy agent may simply use the remote player's instructions, including payment information, to purchase one or more physical bingo cards for play.

In a preferred embodiment, the proxy agent plays the player's bingo cards, such as by daubing numbers or otherwise providing required inputs in order to play the cards, relative to the steps of presenting and playing a bingo game as detailed above in steps S2-S4 of FIG. 1.

Results of the play of the player's bingo cards are reported to the player, either at a kiosk or gaming machine at a facility or at a location away from the casino through an electronic display device. In one embodiment, the result of each bingo card may be reported to the player. In other embodiments, the results of two or more or all of the bingo cards may be reported collectively. A player may choose to see the results on the bingo cards themselves, or the player may elect to view the bingo card outcome through an alternate entertaining display, such as the display of another event such as the display of a roulette, craps, baccarat, slot, card or other game or the like.

As indicated above, winnings are preferably awarded for winning bingo outcomes relative to each bingo card. Relative to local players, the winnings generally comprise the award of monetary credits.

In a preferred embodiment of the invention, however, awards for winning outcomes relative to remote players preferably comprise the award of at least one game card. The at least one game card may comprise one or more additional bingo cards for use in playing the same bingo game or one or more bingo cards for use in playing one or more other games (such as for playing bingo games relative to other ball draws at the same or a later time as the present game). The at least one game card might comprise other types of game cards such as instant-win, scratch-off, pull-tab or other game cards.

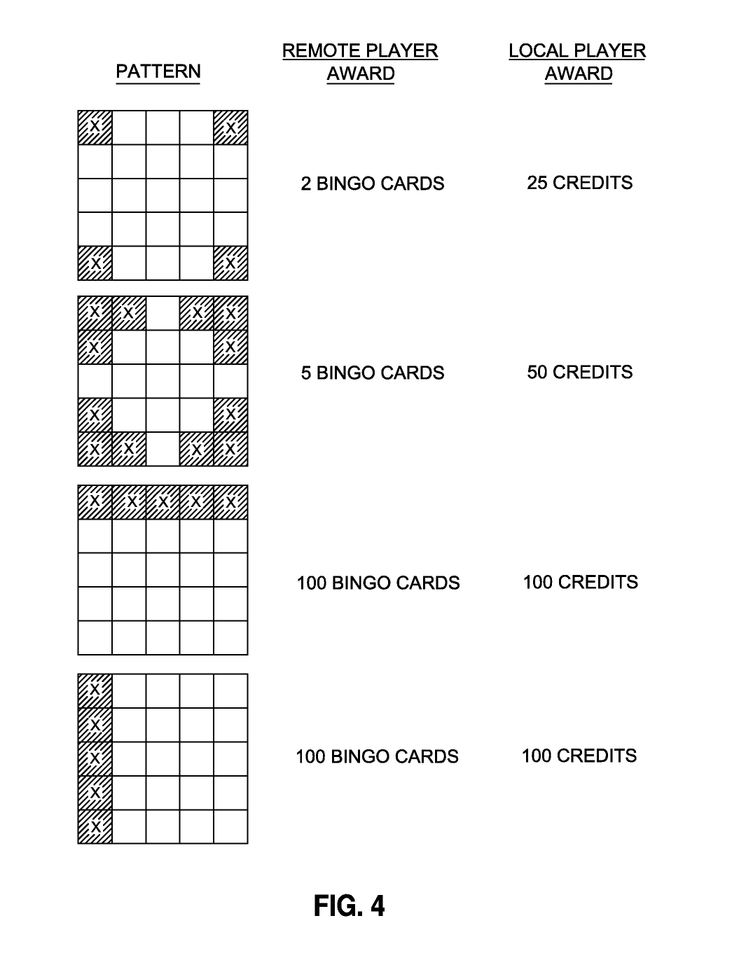

FIG. 4 illustrates one example of a partial pay table for designated winnings outcomes for a bingo game. As illustrated, various awards may be associated with the winning outcomes. Local players may be paid in bingo cards or credits that are available at the facility, while remote players may be awarded bingo cards.

In one embodiment, if a player is awarded one or more game cards, the player may utilize those cards in accordance with designated rules. In one embodiment, the game cards may be used or played without the player being required to place a wager or directing the purchase of more bingo cards, either directly or through a proxy agent. In this manner, the player is afforded an opportunity for additional winnings at no risk or cost to the player. If the one or more cards are bingo cards relative to the existing game, the player may be permitted to put those awarded bingo cards into play immediately. In that event, called bingo balls may be matched against the symbols on the cards for potential matches. The player may thus win additional awards for those cards depending upon their outcome. If the one or more cards are for later games, the player may be required to wait until the start of those games to use the awarded cards.

It will be appreciated that in one embodiment, an award of one or more game cards might lead to the award of additional game cards. For example, if an award in a bingo game is one or more additional bingo cards for play in that same game, those cards might yield winning outcomes having associated awards of additional bingo cards. In this manner, the award of additional game play may result in the award of yet other additional game plays. In such instances, the player's opportunity to win additional credits/monies relative to the game increases, as does the excitement of the game.

In one embodiment, the number of type of game cards which are awarded to the remote player may vary. For example, the bingo cards which may be awarded to the player might be the same denomination and for the same game as those which the player just played, or be of other denominations and/or for other games.

As indicated above, the game outcomes may be reported by a proxy agent or other appropriate interface controller to the remote player on a per card basis or collectively. For example, if 10 bingo cards were played and the player received losing results on cards 1-4 and 6-8, but won 2 cards on bingo card 5 and 100 cards on bingo card 6, the those results might be reported individually to the player or the player might just be informed that they won 102 bingo cards.

If the remote player is awarded bingo cards for winning outcomes, the remote player may elect to have the proxy agent play awarded bingo cards for them immediately or at some time in the future. The player may also direct the proxy agent to the desired play in advance. In another embodiment, the remote player might elect to exchange one or more of their bingo cards for other bingo cards or for other prizes or cash. For example, if a remote player collects 100 $0.01 bingo cards, the player might elect to exchange those cards for a single $1.00 denomination bingo card. Also, the remote player might be permitted to exchange cards for one bingo game for those for play in one or more other bingo games.

The remote player might be permitted to exchange their bingo card winnings for cash or other prizes. For example, a player might be permitted to exchange 100 $1.00 bingo cards for $100. Such an exchange might result in funds in that amount being credited to the player's financial account which the player might then use to purchase other bingo cards in the future or “cash-out” their winnings.

Lastly, in lieu of awarding extra bingo cards, a player may receive awards for winning outcomes in other forms such as product merchandise or other tangible items. In this embodiment, the player may be award such product prizes and may be able to exchange such prizes for additional bingo cards, or cash equivalents.

As one aspect of the invention, the outcome of the one or more bingo cards/game may be presented as a secondary event, as detailed in U.S. Pat. No. 7,322,886, which is incorporated herein in its entirety.

As another aspect of the invention, a bingo game system may be configured to monitor and track players' instructions and the play of bingo cards on their behalf by the proxy agent(s), thereby providing a high level of confidence to the player of the integrity of the game. In one embodiment, all game activity relating to a player and directions to the proxy agent are tracked, such as by a tracking system or host. FIG. 2 illustrates one embodiment of a system which includes a tracking host 140. The tracking host 140 may comprise one or more computing devices and/or associated devices, in various configurations. In one embodiment, the tracking host 140 is configured to monitor and store a player's game play instructions to the proxy agent, such as communicated to or input into a proxy agent station 132. Likewise, the tracking host 140 may be configured to monitor and store game play information via an interface with the game server 130 and accounting information via an interface with the accounting host 134.

As one example, the tracking host 140 may be configured to generate player records and store those records for some period of time. If configured to where a player may remotely transmit instructions to a proxy agent, a record may be created and those instructions may be stored. When the proxy agent executes those instructions, such as by purchasing game cards via the proxy agent station 132, that order may be stored as part of the record. In addition, transfers of funds from the remote player's account may be monitored via the accounting host 134 and corresponding information stored with the record. The tracking host 140 may also record the bingo cards which are assigned to the proxy agent on behalf of the player, the called bingo numbers and the outcomes of each card, including any awards. In this manner, a record is maintained which may be used to audit or confirm the remote player's game play. For example, such a record could be used to ensure that the proxy agent's bingo card order matched the order requested by the remote player.

In one embodiment, a tracking host 140 may be associated with one or more game servers 130. For example, a game server 130 may be provided at first casino A and another at a second casino B for implementing bingo games at those locations. A tracking host 140 could be provided at both locations, or a single tracking host might be configured to monitor and track transactions and events at both casinos.

In another embodiment, in addition to a tracking host, the system may be provided with redundant servers or other devices for all aspects of the system that involve particular functionality, such as from when a player establishes a patron account through when a proxy agent plays cards for a player, whether at the bingo game or at remote location. The redundant server(s) may track and record all financial and play transactions and directions and may be maintained at a remote location from the bingo game facilities. These servers could also be utilized to record and verify all transactions required through the various interface controllers that comprise the invention.

The invention has particular utility to bingo games, but as indicated above, might be applied to other types of games such as keno, pull-tab, lotto or other games. In this regard, while the game may be a bingo game played with cards having numbers or other designations for matching to objects (such as bingo balls) similarly numbered or designated. The award structure, however, has particular applicability to games played with game cards, wherein the award of additional game cards for the game afford additional chances to play the game and win awards.

Various aspects of the invention will be appreciated. In accordance with the invention, a remote player is permitted to participate in a bingo game with the aid of a proxy agent or player. This enables the remote player to participate in game play without being physically present at the location where the game is presented.

Preferably, players utilizing a proxy agent are awarded one or more game cards for winning game outcomes. First, this greatly simplifies the accounting associated with remote player game play. As indicated, in a preferred embodiment a remote player is required to establish and utilize a financial account to initially fund the purchase of bingo cards. In accordance with the invention, however, the complexities associated with transferring and converting monetary/credit wins from the gaming system to the remote player's account and then having to transfer those funds back to the game system for the purchase of additional game cards, is avoided. Instead, a remote player is directly awarded game cards which the player can directly play without any conversion.

Another benefit of this aspect of the invention is that it provides a remote player with the opportunity for additional instances of game play. This substantially increases the excitement associated with the game. In the game of bingo, substantial excitement is generated as a player watches their card and compares called balls to their card. This level of excitement will be heightened if the player wins additional bingo cards for play, as the player then has the opportunity to await the outcome of the additional cards.

The award feature also increases the probability of winning outcomes to the player. Whether such is via an instant-win card or another bingo card, the award of such cards to the player presents additional opportunities for game wins to the player.

As will be appreciated, the award of bingo cards for play in the same bingo game represents a substantial deviation from other types of game awards, including mystery and bonus awards which are common in slot type gaming machines. For example, in a slot game some winning outcomes may simply have associated awards of credits. Other winning outcomes might trigger a secondary display or “bonus event” which yields the player an award. In such instances, however, the game is configured so that the bonus event represents a predetermined outcome. In this manner, the game operator retains complete control over the volatility of the game, including the total payout to players relative to wagers (i.e. the “payout percentage”). This award scheme would also be applicable in the event players are awarded merchandise products in lieu of additional bingo cards that may be exchanged at a later date for additional cards or cash equivalents.

However, the award of additional game cards or other merchandise products represents a significant deviation from such a configuration. An award of a game card to a player may present an opportunity for a range of awards which can not be determined when the card is awarded. For example, in a bingo game the award of an additional bingo card presents an opportunity for a win, but the probability and value of such a win is not controlled, but is instead dependent upon the then unknown outcome of the game which depends upon the number of cards in play, the bingo balls which are randomly selected during play of the game and the like.

As one aspect of the invention, an award might comprise bingo cards for play in other games. Such a configuration also represents a deviation from current awards. In such a configuration, the bingo cards might be awarded for play in a different type of bingo game. Such a bingo game might comprise a game which includes only bingo cards awarded in the play of earlier bingo games, rather than including bingo cards purchased by players. In this manner, the number of bingo cards played in the later game(s) may be controlled. Further, the configuration of the later game(s) may be controlled so that the payback percentage is carefully controlled. The payout of those later games may be attributed back to the original bingo game(s) when considering the pay tables for those games so as to ensure that the payout percentages (and thus the house hold) for those games is carefully controlled.

In accordance with the invention, it will be appreciated that multiple players may participate in play of bingo games via one proxy agent or multiple proxy agents whether at a casino location or having game outcomes revealed at a remote locations. For example, a single proxy agent may play bingo games on behalf of multiple remote players. A single casino might have one proxy agent or it might have multiple proxy agents available at various times in order to service remote players.

In one embodiment, remote players preferably establish one or more financial accounts with one or more game providers (such as casinos) which the proxy agent uses to purchase bingo cards on behalf of the remote player. In other embodiments, it is possible that the remote player might engage directly in a funds transaction which results in the assignment of bingo cards to the proxy agent on behalf of the remote player.

As indicated above, existing laws impact the ability of players in certain locations from directly placing wagers on wagering events. In one embodiment, a remote player might purchase one or more goods or services from a game provider and the game provider might assign game cards to the player for play, such as by a proxy agent or directly. For example, a casino might offer various goods or services via a website, catalog or the like. A remote player might purchase goods via the website using a credit or debit card or the like (i.e. without having funds on account with the casino), wherein the financial transaction is affected by the remote player from their location, as is common relative to standard “on-line” or “e-commerce” transactions. In accordance with the invention, the game provider may award one or more bingo cards to the player for free or as a compliment to their purchase. The player or a proxy agent may then play these bingo cards, providing the remote player with the opportunity for a gaming experience.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A bingo game comprising the steps of:
a proxy agent receiving a request from a player to play a bingo game;
the proxy agent purchasing at least one bingo card for said player;
assigning at least one bingo card bearing numbers or other designations associated therewith to said proxy agent on behalf of said player;
drawing at least one first set of bingo balls having associated numbers or designations and comparing said bingo balls to said numbers or designations associated with said bingo cards;
determining if said comparing results in at least one designated winning outcome for said bingo game and, if so, awarding an award to said player in accordance with a pay table, said pay table defining awards for winning outcomes of said game, said awards for winning outcomes comprising at least one game card; and
providing information regarding said results of said at least one designated winning outcome to said player.

2. The bingo game in accordance with claim 1 wherein said at least one game card comprises at least one additional bingo card for said bingo game.

3. The bingo game in accordance with claim 1 wherein said at least one game card comprises at least one bingo card for another bingo game.
